(19) United States
(12) Patent Application Publication
(10) Pub. No.: US 2025/0307093 A1
(43) Pub. Date: Oct. 2, 2025

(54) STREAMLINED MIXED MODE DECODE ANALYSIS FOR SERIAL BUS PROTOCOLS

(71) Applicant: Tektronix, Inc., Beaverton, OR (US)

(72) Inventors: Archana I. Akkalakot, Bengaluru (IN); Abhilash Baruah, Bengaluru (IN); Shyam Sunder C K, Bengaluru (IN); Alka Kumari, Bengaluru (IN); Akshay Gupta, Bengaluru (IN)

(21) Appl. No.: 19/083,240

(22) Filed: Mar. 18, 2025

(30) Foreign Application Priority Data
Mar. 29, 2024 (IN) 202421025916
Aug. 1, 2024 (IN) 202421058445

(51) Int. Cl. G06F 11/22; G06F 11/273

(52) U.S. Cl. CPC G06F 11/221; G06F 11/2247; G06F 11/2733

(57) ABSTRACT

A test and measurement instrument includes one or more ports to connect one or more devices under test (DUTs) through a serial bus to one or more channels, a user interface to allow a user to provide inputs to including a designation of mixed mode for the serial bus, a display to allow a user to view information about the one or more DUTs, one or more processors to: receive one or more packets from one DUT of the one or more DUTs; determine a version of a serial bus standard with which the one DUT complies by identifying a characteristic of the packet; use the version of the serial bus standard to decode the packet to produce decoded data; and analyze the decoded packet to monitor traffic on the serial bus and determine if the one DUT of the one or more DUTs is operating correctly.

### CROSS-REFERENCE TO RELATED APPLICATIONS

This disclosure claims priority under 35 U.S.C. § 119 to Indian Provisional Patent Application No. 202421025916, titled “STREAMLINED MIXED MODE CAN NETWORK PROTOCOL ANALYSIS VIA CANXL DECODING,” filed on Mar. 29, 2024, and Indian Provisional Patent Application No. 202421058445, titled “MIXED MODE DECODE OPTION FOR HIGHSPEED SERIAL BUS PROTOCOL DECODE,” filed on Aug. 1, 2024, the disclosures of both of which are incorporated herein by reference in their entirety.

### TECHNICAL FIELD

The present disclosure relates to decoding and analysis of serial bus data that follows a certain protocol, particularly in decoding and analyzing data in a mixed mode networks that have devices using different versions of the protocol.

### BACKGROUND

The evolution of computers with larger data rate capabilities has led to communication protocols with increased the speeds of operation. Some of the newer standards with increased speeds have backward compatibility to the older standards, but the packet structures are different for each standard. This is true for both low-speed serial buses and high-speed serial buses.

For example, the Controller Area Network (CAN) standards, a low-speed serial bus, come in four different versions. CAN 2.0 was first and supports data rates up to 1 Mbps with 8 bytes per message. CANFD 1.0 (CAN Flexible Data rate) supports data rates up to 5 Mbps with 64 bytes per message. This standard came in non-ISO and ISO (International Standards Organization) versions, but the non-ISO version has largely fallen out of use. CANXL, meaning CAN with extended field Length, supports data rates up to 20 Mbps with 2048 bytes per message. The ISO standard 11899-1 includes CANXL standards. The CANXL standard intends to bridge the bit rate gaps between CAN/CANFD and Ethernet 100Base-T1.

Because the CAN standards operation at different data rates, users testing a CAN network has to configure the selected CAN bus standard every test. If the user wants to monitor data across the entire network, they need to add different buses for the different standards. This makes it difficult to co-relate the data coming from different bus standards in one network. Further, each CAN standard has a different packet structure, making it difficult to search and identify packets from each CAN standard individually with the multiple buses that the user defined.

Universal Serial Bus (USB) provides another serial bus standard that has evolved such that different versions of the standard have different data rates. USB is a high-speed serial bus. Other serial bus standards include PCIe (Peripheral Component Interconnect Express) and DisplayPort. The ability to verify operation of the devices under test (DUTs) by looking at transmissions between devices of different versions of a bus standard has the same limitations.

### BRIEF DESCRIPTION OF THE DRAWINGS

FIG. 1 shows a diagram of a test and measurement instrument connectable to one or more devices under test (DUTs).

FIG. 2 shows a flowchart of an embodiment of a method to detect a serial bus standard from a characteristic of a packet on the serial bus.

FIG. 3 shows a diagram of an embodiment of a Controller Area Network (CAN) including devices of mixed CAN standards.

FIG. 4 shows an embodiment of a user interface allowing selection of a mixed mode.

FIGS. 5A-5B shows diagrams of different frame structures of different CAN standards.

FIG. 6 shows a flowchart of an embodiment of a method of identifying a CAN standard.

FIG. 7 shows an image of a decoded data from a CAN 2.0 device.

FIG. 8 shows an image of a decoded data from a CANXL, CAN 2.0, and CANFD frames in mixed mode.

FIG. 9 shows a graphic of multiple USB standards connected to a USB hub.

FIG. 10 shows a graphic showing a test and measurement instrument connected to a USB hub.

FIG. 11 shows an embodiment of a user interface allowing for mixed mode in USB standards.

FIG. 12 shows a flowchart of an embodiment of a method of determining the type of USB packets for decoding.

FIG. 13 shows an image of decoded data for a USB v.2.0.

FIG. 14 shows an image of decoded data for USB v.3.0.

### DETAILED DESCRIPTION

The embodiments herein relate to capabilities for test and measurement instruments to verify operation of devices under test (DUTs) as the DUTs send data on a serial bus. This capability allows for different devices on the same bus use different versions of a serial bus standard without requiring the user to designate different devices to be on a different bus. This allows the user to decode and analyze bus data for different versions of a serial bus standard without having to change the configuration.

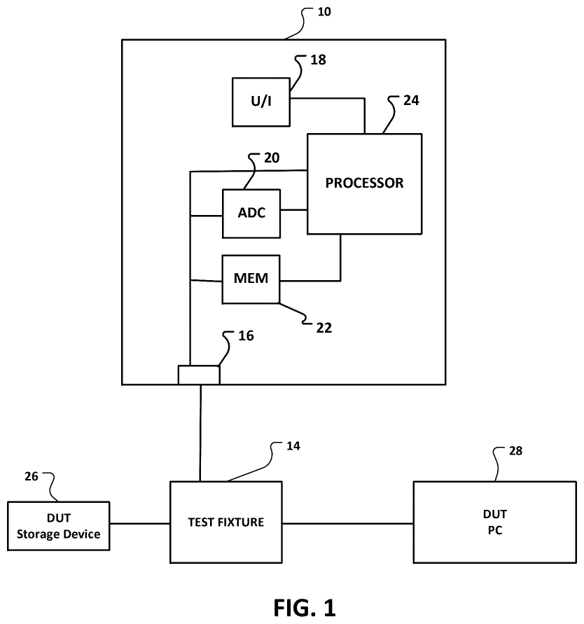

FIG. 1 shows an embodiment of a test and measurement instrument. The test and measurement instrument 10 connects to a text fixture 14 that is in turn connected to one or more DUTs 26 and 28. In one embodiment, the DUT 26 may comprise a storage device, and the DUT 28 may comprise a PC. The connection may involve one or more probes on the test fixture. While these will both be referred as DUTs, decoding operation applies to whichever of the computing device 28 or the storage device 26 is transmitting the data. The test fixture 14 sends the USB data through one or more channels 16 on test and measurement instrument 10. In some embodiments, the test fixture 14 may comprise a probe. As discussed above, the embodiments herein will typically only use one probe and one channel of the instrument, but more may be used.

The data from the test fixture 14, if analog, undergoes conversion to digital by one or more analog-to-digital converters (ADC), such as ADC 20. The ADC 20 converts the analog data to digital data for the one or more processors such as processor 24 to operate upon the digital data. If the data received comprises digital data, the digital data bypasses ADC 20. The test and measurement instrument 10 may include a memory 22 to allow the one or more processors 24 to store the digital and analog data and may contain the code to be executed by the one or more processors 24. User interface 18 allows the test and measurement instrument 10 to display at least the resulting current measurement to the user, and may include controls such as buttons, knobs, sliders, trackballs, etc., to allow the user to perform operations on the incoming signals, etc.

The test fixture 14 may provide a communication bus using a serial bus standard such as Controller Area Network (CAN), Universal Serial Bus (USB), Peripheral Component Interconnect Express (PCIe), and DisplayPort. Devices 26 and 28 connected to the test fixture may transmit and receive data across the bus to the test and measurement instrument 10 or other devices connected to the test fixture 14. While the configuration may include the text fixture 14, it could also be replaced with probes. In some embodiments the text fixture 14 may take the form of a USB hub, as will be discussed in more detail later. The setup may have other variations for different protocols.

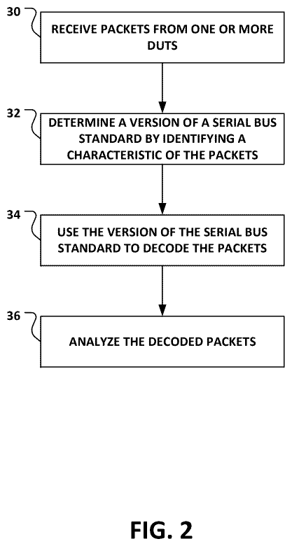

FIG. 2 shows a flowchart of an embodiment of a method to detect the serial bus type with which the DUT complies from a characteristic of the data transmitted by the DUT. The test and measurement device receives packets from the one or more DUTs at 30. The one or more processors in the test and measurement instrument will execute code to perform the methods of the embodiments. At 32 they will analyze a characteristic of the packet to determine the version of the bus standard under which the device operates. This characteristic may comprise one or more of many things including the speed by which the DUT transmits packets, the internal format of the packet, which may include the values of certain key bits.

Once the instrument has determined the version of the serial bus standard used by the DUT, it can then decode the packets for the particular version at 34. This will allow the user to analyze transmission errors and analyze the different device requests coming at different time intervals. The embodiments avoid adding separate serial buses for each standard or having to keep changing the speed of the USB bus in the bus configuration menu.

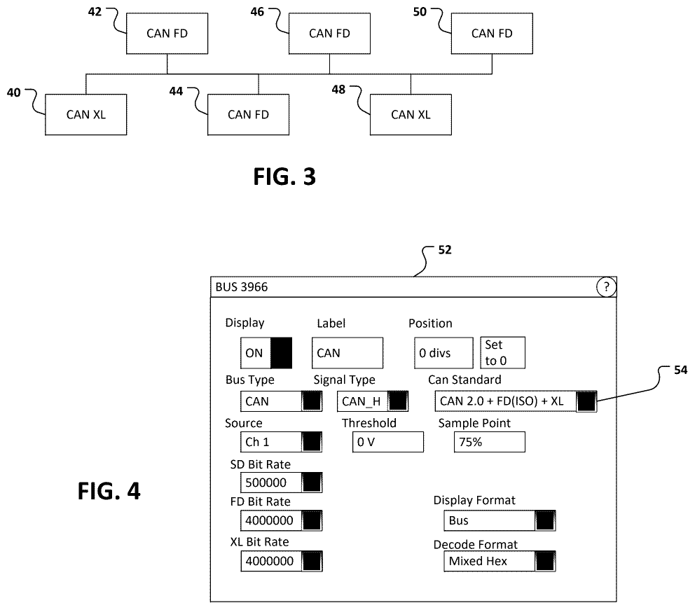

FIG. 3 shows an embodiment of a network having devices that operate with different standards under the CAN standard. The various devices operate under different CAN standards. In the example, devices 40 and 48 operate under the CAN XL standard that operate at speeds up to 16 Mbps. Devices 42, 44, 46, and 50 operate under CAN FD which operates at speeds up to 5 Mbps. FIG. 4 shows a menu at the user interface 52 of the test and measurement instrument. In FIG. 4, the user can select the mixed mode from the drop down 54 that includes CAN 2.0, CAN FD, and CAN XL. The informs the test and instrument that the devices being tested are of different CAN standards. For completeness, the other fields include Source, which selects the source where the signal is connected to the input channel, the Threshold allows designation of the threshold level for the bus to detect a ‘1’ or a ‘0.’ Sample Point allows defining the duration of the bit where the frequency changes in percentage. The fields SD Bit Rate, FD Bit Rate, and XL Bit Rate allow setting for the custom bit rate for the standard (SD), flexible data rate (FD), and extended length bit rate (XL).

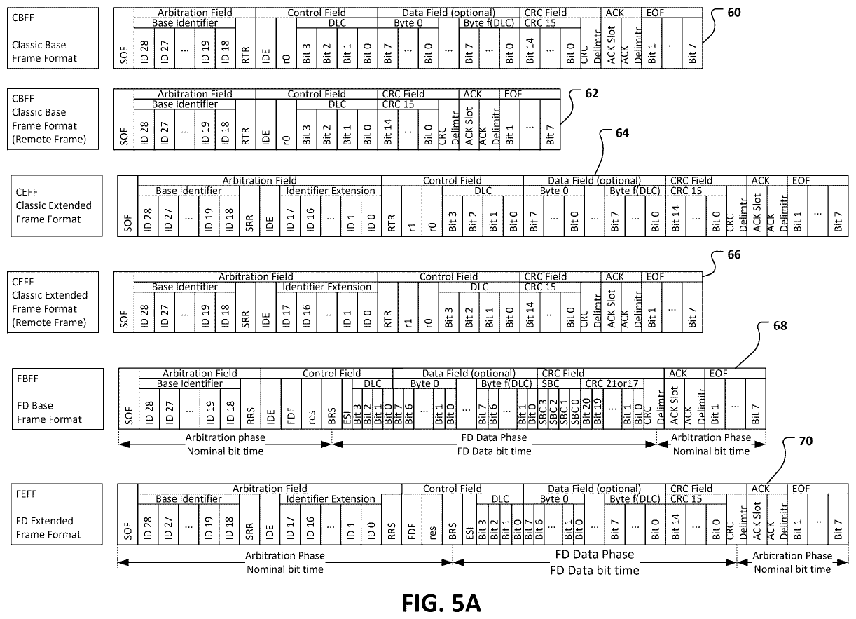

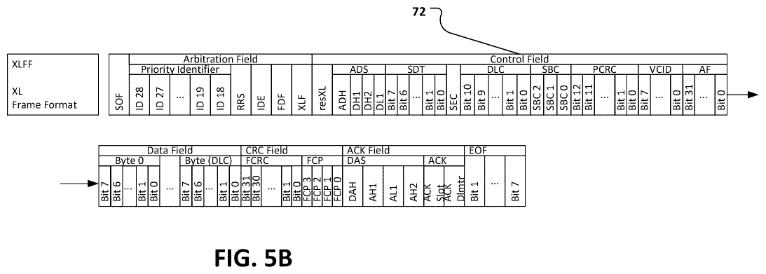

FIGS. 5A-5B shows the different formats of packets from the different CAN standards. Frame 60 shows the format for the classic base frame format. Frame 62 shows the classic base frame format for a remote frame. Frame 64 sows the classic extended frame format. Frame 66 shows the frame format of classic extended frame format for remote frames. As used here, the term “classic” refers to the CAN 2.0 standard. Frame 68 shows the frame format for the flexible data base frame format. Frame 70 shows the frame format for the flexible data rate extended frame format. FIG. 5B shows the frame 72 for a CAN extended length frame.

As can be seen by these frames, there are some key bits that can be used to identify the frames. SRR (Substitute Remote Request) bit and IDE (Identifier Extnsion) bit of CAN extended frame which are always Recessive (‘1’) helps to differentiate between CAN and CAN Extended packets. In each standard, after 11 bits of Identifier, next three bits help us to differentiate between all non extended frame packets, 000 is for CAN 2.0 Data, 100 is for CAN 2.0 Remote, 001 is for CAN FD, and 011 is for CANXL.

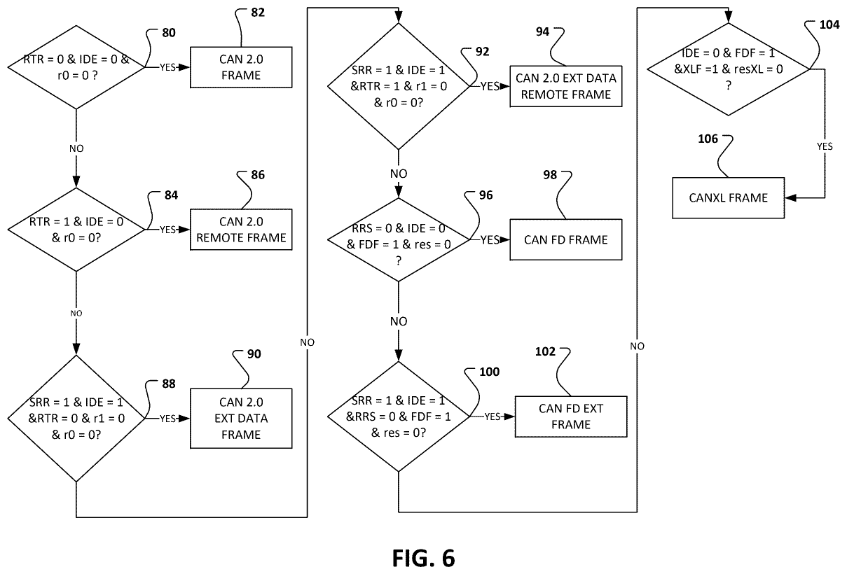

FIG. 6 shows a flowchart of an embodiment of a method of determine the CAN standard under which the DUT is transmitting the packets received by the instrument. When the packet is initially received, at 80 the determination is made as to whether the RTR bit is 0, the IDE bit is 0 and if r0 is 0. If these are all true, then it is a CAN 2.0 frame at 82. The bits r0 and r1 are control bits.

At 84, if the RTR bit is 1 and the other two bits are 0, then it is a CAN 2.0 remote frame at 86. At 88, if the SRR bit is 1, the IDE bit is 1, RTR is 0, r1 is 0 and r0 is 0, then it is a CAN 2.0 extended data frame at 90. The process continues to 92, where, if the SRR bit is 1, IDE is 1, RTR is 1, r1 is 0, and r0 is 0, it is a CAN 2.0 extended data remote frame at 94. At 96, if the RRS bit, (Remote Request Substitution) is 0 and IDE is 0, the FDF bit is 1, and res is 0, then it is a CAN FD frame at 98. FDF is the bit that distinguishes between classical CAN and CAN FD frames. The ‘res’ bit is a reserved bit. At 100, if the SRR is 1, the IDE is 1, RRS is 0, the FDF is 1, and res is 0, the frame is a CAN FD extended frame 102. Finally, at 104, if the IDE is 0, FDF is 1, XLF and 1 and resXL is 0, the frame is a CANXL Frame at 106. The XLF is a bit that identifies the XLF frame and the resXL bit is the reserved bit for XL frames.

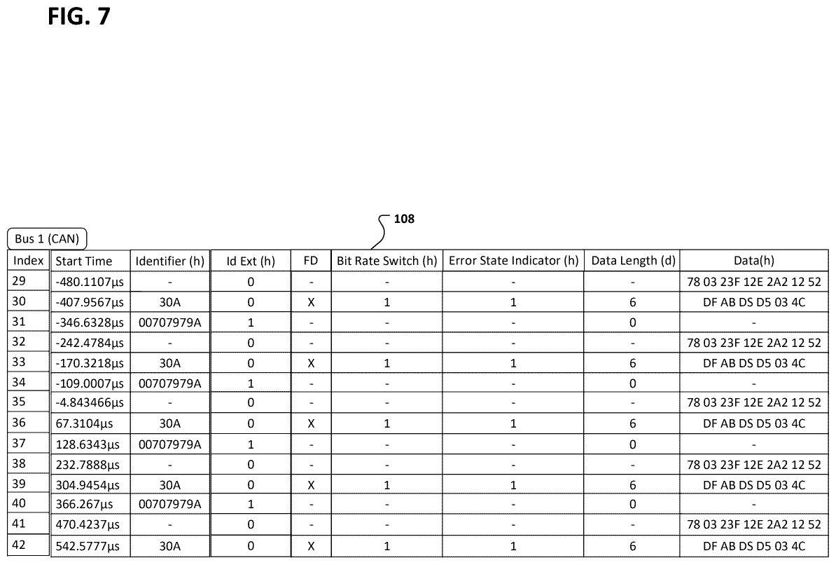

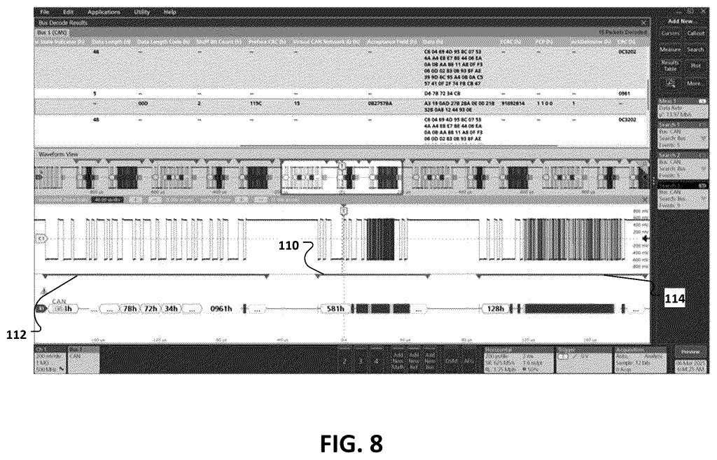

FIG. 7 shows an image 108 on an oscilloscope screen of a decoded CAN 2.0 package in the mixed mode. FIG. 8 shows an image of a decoded CANXI, CAN 2.0, and CAN FD frames in Mixed mode. The image shows search marks for CANXL frames 110, CANFD at 114 and CAN 2.0 at 112.

The above discussion focuses on the CAN standard. However, the process of the embodiments applies to other standards. The discussion now turns to Universal Serial Bus (USB). USB standards include USB 1.0, 1.1, 2.0, 3.0, 3.1 Gen 1, 3.2 Gen 1, 3.2, and Gen 2.

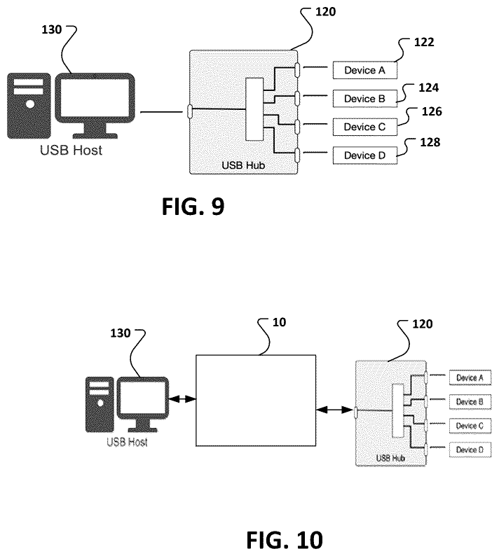

FIG. 9 shows a configuration where several devices, Device A-B, 122-128, are connected to a USB hub 120. In some embodiments, the USB hub 120 operates in this configuration as a test fixture. In some embodiments, the USB hub may connect to a computing device 130 that hosts the USB hub.

In one embodiment, Device A 122 complies with USB v.2.0, Device B, 124, Device C, 124, and Device C, 128 are 3.x compliant. When communications occur between the host 130 and hub 120 when all the devices are connected, the speed automatically drops to 480 Mbps. The user will not know the selected speed until the user checks the speed.

When trying to decode the US communications to determine transmission errors, the user may employ an oscilloscope (“scope”) to capture either the transmitted or received signal. This configuration is shown in FIG. 10. The scope may connect to the hub or the host, whichever allows the scope to detect and track the transmissions across the bus. To allow the user to decode the data at the scope to determine if errors exist in the transmission, the scope should identify the version of the USB standard to which the device complies. By adding the capability to the scope to allow the scope to track the data rate.

Prior to the embodiments here, the user had to select a particular speed to get the proper decode of the acquired data. In one situation, if Device A 122 disconnects from the hub, the speed then changes automatically to 5 Gbps as all the remaining devices are v3.0 compliant. The user would then have to change the bus configuration settings and select the proper speed to decode the data.

By adding the option to the scope or instrument, even changing the speed on the bus because of the addition or subtraction of a particular device, like Device A 122, would not require the user to reconfigure the bus. The scope would detect the speed and then automatically identify the device's standard.

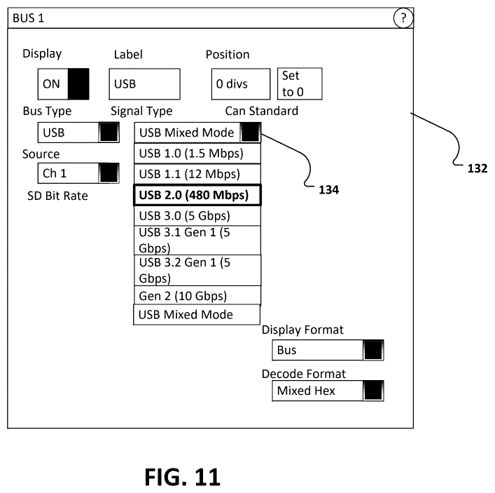

FIG. 11 shows an embodiment of a user interface 132 that allows the user to select the mixed mode 134 for the bus. The mixed mode means that the instrument now “knows” that devices on the bus may comply with different versions of the bus standard. Other portions of the interface allow the users to identify the Source, the display format, and the threshold, which allows the bus to detect between a 0 and a 1. The DUT undergoing testing generally has a set of guidelines that include the data rate at which the device operates. The vendors may have fixed this speed. If the user does not know the data rate, the user can add the data rate measurement, and then can select the same in a dedicated “Data Rate” drop down list for each standard.

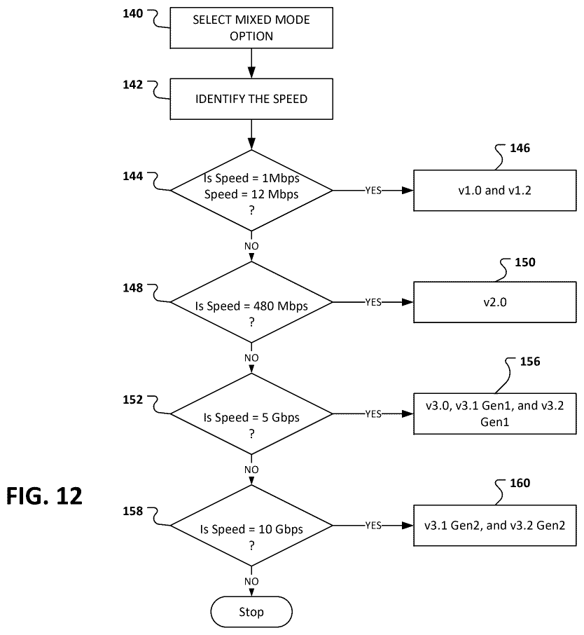

FIG. 12 shows a flowchart of a method of detecting the USB standard based upon the characteristics the speed of transmission of the packet. At 140, the instrument receives the instruction to operate in the mixed mode. At 142, the instrument detects the speed of the transmission. The one or more processors then execute code to determine with what USB standard the device sending the transmission complies. At 144 the process then begins the process of using the speed to identify the bus standard. If the speed is between 1 and 12 Mbps, the device transmission is coming from a device that complies with v1.0 or v1.2 at 146. If the speed is 480 Mbps at 148, then the packet is identified and decoded as v2.0 at 150. If the speed is 5 Gbps at 152, then the packet is identified and decoded as v3.0, v.3.1 Gen1 or v3.2 Gen 1 at 154. If the speed is 10 Gbps at 156, the packets are decoded as v3.1 Gen 2 or v3.2 Gen 2 at 160.

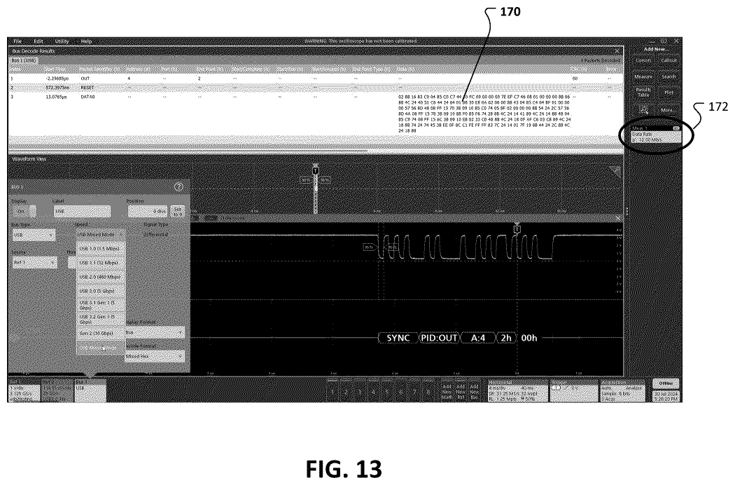

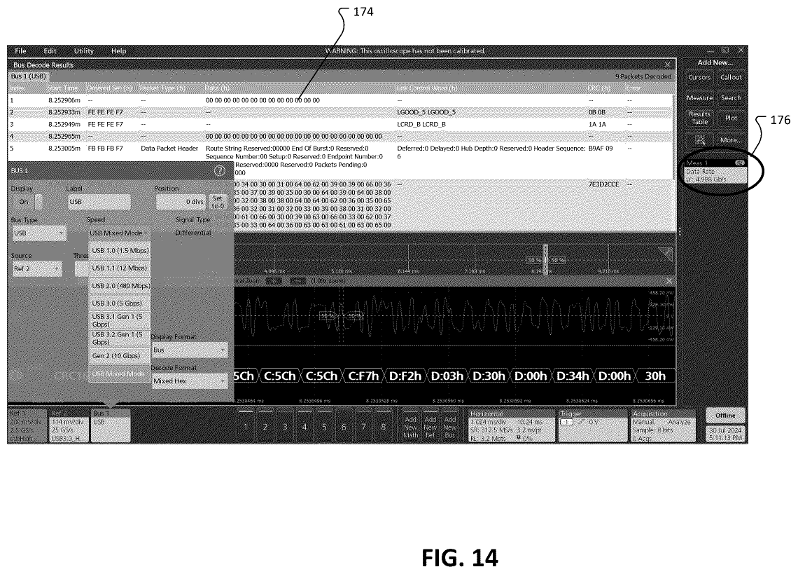

FIG. 13 shows the decoded data for USB v2.0 on a screen 170 of an instrument. Note that the data rate badge 170 shows the speed to be 12.00 Mbps. FIG. 14 shows decoded data for USB v3.0 on the screen 174 of the instrument when in mixed mode. The data rate badge 176 shows the speed to be 5 Gbps.

In this manner, a user can decode and analyze the data packets from DUTs under a serial bus standard, without having to designate the version of the bus. The above examples show CAN and USB bus standards, with the understanding that these are examples of how characteristics of the packets, such as their speed or key bits, can allow an instrument to automatically detect and then decode the packets.

Aspects of the disclosure may operate on a particularly created hardware, on firmware, digital signal processors, or on a specially programmed general-purpose computer including a processor operating according to programmed instructions. The terms controller or processor as used herein are intended to include microprocessors, microcomputers, Application Specific Integrated Circuits (ASICs), and dedicated hardware controllers. One or more aspects of the disclosure may be embodied in computer-usable data and computer-executable instructions, such as in one or more program modules, executed by one or more computers (including monitoring modules), or other devices. Generally, program modules include routines, programs, objects, components, data structures, etc. that perform particular tasks or implement particular abstract data types when executed by a processor in a computer or other device. The computer executable instructions may be stored on a non-transitory computer readable medium such as a hard disk, optical disk, removable storage media, solid state memory, Random Access Memory (RAM), etc. As will be appreciated by one of skill in the art, the functionality of the program modules may be combined or distributed as desired in various aspects. In addition, the functionality may be embodied in whole or in part in firmware or hardware equivalents such as integrated circuits, FPGA, and the like. Particular data structures may be used to more effectively implement one or more aspects of the disclosure, and such data structures are contemplated within the scope of computer executable instructions and computer-usable data described herein.

The disclosed aspects may be implemented, in some cases, in hardware, firmware, software, or any combination thereof. The disclosed aspects may also be implemented as instructions carried by or stored on one or more or non-transitory computer-readable media, which may be read and executed by one or more processors. Such instructions may be referred to as a computer program product. Computer-readable media, as discussed herein, means any media that can be accessed by a computing device. By way of example, and not limitation, computer-readable media may comprise computer storage media and communication media.

Computer storage media means any medium that can be used to store computer-readable information. By way of example, and not limitation, computer storage media may include RAM, ROM, Electrically Erasable Programmable Read-Only Memory (EEPROM), flash memory or other memory technology, Compact Disc Read Only Memory (CD-ROM), Digital Video Disc (DVD), or other optical disk storage, magnetic cassettes, magnetic tape, magnetic disk storage or other magnetic storage devices, and any other volatile or nonvolatile, removable or non-removable media implemented in any technology. Computer storage media excludes signals per se and transitory forms of signal transmission.

Communication media means any media that can be used for the communication of computer-readable information. By way of example, and not limitation, communication media may include coaxial cables, fiber-optic cables, air, or any other media suitable for the communication of electrical, optical, Radio Frequency (RF), infrared, acoustic or other types of signals.

### EXAMPLES

Illustrative examples of the disclosed technologies are provided below. An embodiment of the technologies may include one or more, and any combination of, the examples described below.

Example 1 is a test and measurement instrument, comprising: one or more ports to connect one or more devices under test (DUTs) through a serial bus to one or more channels of the test and measurement instrument; a user interface to allow a user to provide inputs to the test and measurement instrument including a designation of mixed mode for the serial bus; a display to allow a user to view information about the one or more DUTs; one or more processors configured to execute code that causes the one or more processors to: receive one or more packets from one DUT of the one or more DUTs; determine a version of a serial bus standard with which the one DUT complies by identifying a characteristic of the packet; use the version of the serial bus standard to decode the packet to produce decoded data; and analyze the decoded data to monitor traffic on the serial bus and determine if the one DUT of the one or more DUTs is operating correctly.

Example 2 is the test and measurement instrument of Example 1, wherein the mixed mode comprises a mode in which the devices operate using a single bus without regard to versions of the serial bus standard to which each of the one or more DUTs comply.

Example 3 is the test and measurement instrument of either of Examples 1 or 2, wherein the serial bus comprises a Controller Area Network (CAN) bus.

Example 4 is the test and measurement instrument of Example 3, wherein the version of the serial bus standard comprises one of CAN 2.0, CAN with flexible data rate (CANFD), and CAN with extended data field length (CANXL).

Example 5 is the test and measurement instrument of any of Examples 1 through 4, wherein the code that causes the one or more processors to determine the version of the serial bus standard by the identifying the characteristic of the packet comprises identifying one or more key bits.

Example 6 is the test and measurement instrument of Example 5, wherein the one or more key bits comprise at least one of Remote Transmission Request (RTR), Identifier Extension (IDE), Remote Request Substitution (RRS), Substitute Remote Request (SRR), control bit r0, control bit r1, reserved bit res, FDF, XLF, and resXL.

Example 7 is the test and measurement instrument of any of Examples 1 through 6, wherein the one or more processors are further configured execute code to cause the one or more processors to display the decoded data with search marks to allow the user to identify the data from different versions of the serial bus standard.

Example 8 is the test and measurement instrument of any of Examples 1 through 7, wherein the serial bus comprises a Universal Serial Bus (USB).

Example 9 is the test and measurement instrument of Example 8, wherein the version of the serial bus standard comprises one of USB 1.0, USB 1.1, USB 2.0, USB 3.0, USB 3.1, USB 3.2 Gen 1, USB 3.0 Gen 2.

Example 10 is the test and measurement instrument of Example 8, wherein the code that causes the one or more processors to determine the version of the serial bus standard by identifying the characteristic of the packet comprises code that causes the one or more processors to identify a data rate at which the packet had been transmitted.

Example 11 is a method, comprising: receiving an input from a user that sets a mode for a test and measurement instrument to a mixed mode indicating that packets may be from one or more versions of a serial bus standard; receiving one or more packets from one DUT of one or more DUTs; determining a version of the serial bus standard with which the one DUT complies by identifying a characteristic of the packet; using the version of the serial bus standard to decode the packet to produce decoded data; and displaying the decoded data on a user interface of the test and measurement instrument.

Example 12 is the method of Example 11, wherein the mixed mode comprises a mode in which the devices operate using a single bus without regard to versions of the serial bus standard to which each of the one or more DUTs comply.

Example 13 is the method of either of Examples 11 or 12, wherein the serial bus comprises a Controller Area Network (CAN) bus.

Example 14 is the method of Example 13, wherein the version of the serial bus standard comprises one of CAN 2.0, CAN with flexible data rate (CANFD), and CAN with extended data field length (CANXL).

Example 15 is the method of any of Examples 11 through 13, wherein determining the version of the serial bus standard by the identifying the characteristic of the packet comprises identifying one or more key bits.

Example 16 is the method of Example 15, wherein the one or more key bits comprise at least one of a Remote Transmission Request (RTR), Identifier Extension (IDE), Remote Request Substitution, (RRS), Substitute Remote Request (SRR), control bit r0, control bit r1, reserved bit res, FDF, XLF, and resXL.

Example 17 is the method of any of Examples 11 through 16, further comprising displaying the decoded data with search marks to allow the user to identify data from different versions of the serial bus standard.

Example 18 is the method of any of Examples 11 through 17, wherein the serial bus comprises a Universal Serial Bus (USB).

Example 19 is the method of Example 18, wherein the version of the serial bus standard comprises one of USB 1.0, USB 1.1, USB 2.0, USB 3.0, USB 3.1, USB 3.2 Gen 1, USB 3.0 Gen 2.

Example 20 is the method of Example 19, wherein determining the version of the serial bus standard by identifying the characteristic of the packet comprises identifying a data rate at which the packet had been transmitted.

The previously described versions of the disclosed subject matter have many advantages that were either described or would be apparent to a person of ordinary skill. Even so, these advantages or features are not required in all versions of the disclosed apparatus, systems, or methods.

All features disclosed in the specification, including the claims, abstract, and drawings, and all the steps in any method or process disclosed, may be combined in any combination, except combinations where at least some of such features and/or steps are mutually exclusive. Each feature disclosed in the specification, including the claims, abstract, and drawings, can be replaced by alternative features serving the same, equivalent, or similar purpose, unless expressly stated otherwise.

Additionally, this written description makes reference to particular features. It is to be understood that the disclosure in this specification includes all possible combinations of those particular features. Where a particular feature is disclosed in the context of a particular aspect or example, that feature can also be used, to the extent possible, in the context of other aspects and examples.

Also, when reference is made in this application to a method having two or more defined steps or operations, the defined steps or operations can be carried out in any order or simultaneously, unless the context excludes those possibilities.

Although specific examples of the invention have been illustrated and described for purposes of illustration, it will be understood that various modifications may be made without departing from the spirit and scope of the invention. Accordingly, the invention should not be limited except as by the appended claims.

1. A test and measurement instrument, comprising:
one or more ports to connect one or more devices under test (DUTs) through a serial bus to one or more channels of the test and measurement instrument;
a user interface to allow a user to provide inputs to the test and measurement instrument including a designation of mixed mode for the serial bus;
a display to allow a user to view information about the one or more DUTs;
one or more processors configured to execute code that causes the one or more processors to:
receive one or more packets from one DUT of the one or more DUTs;
determine a version of a serial bus standard with which the one DUT complies by identifying a characteristic of the packet;
use the version of the serial bus standard to decode the packet to produce decoded data; and
analyze the decoded packet to monitor traffic on the serial bus and determine if the one DUT of the one or more DUTs is operating correctly.

2. The test and measurement instrument as claimed in claim 1, wherein the mixed mode comprises a mode in which the devices operate using a single bus without regard to versions of the serial bus standard to which each of the one or more DUTs comply.

3. The test and measurement instrument as claimed in claim 1, wherein the serial bus comprises a Controller Area Network (CAN) bus.

4. The test and measurement instrument as claimed in claim 3, wherein the version of the serial bus standard comprises one of CAN 2.0, CAN with flexible data rate (CANFD), and CAN with extended data field length (CANXL).

5. The test and measurement instrument as claimed in claim 1, wherein the code that causes the one or more processors to determine the version of the serial bus standard by the identifying the characteristic of the packet comprises identifying one or more key bits.

6. The test and measurement instrument as claimed in claim 5, wherein the one or more key bits comprise at least one of Remote Transmission Request (RTR), Identifier Extension (IDE), Remote Request Substitution (RRS), Substitute Remote Request (SRR), control bit r0, control bit r1, reserved bit res, FDF, XLF, and resXL.

7. The test and measurement instrument as claimed in claim 1, wherein the one or more processors are further configured execute code to cause the one or more processors to display the decoded data with search marks to allow the user to identify data from different versions of the serial bus standard.

8. The test and measurement instrument as claimed in claim 1, wherein the serial bus comprises a Universal Serial Bus (USB).

9. The test and measurement instrument as claimed in claim 8, wherein the version of the serial bus standard comprises one of USB 1.0, USB 1.1, USB 2.0, USB 3.0, USB 3.1, USB 3.2 Gen 1, USB 3.0 Gen 2.

10. The test and measurement instrument as claimed in claim 8, wherein the code that causes the one or more processors to determine the version of the serial bus standard by identifying the characteristic of the packet comprises code that causes the one or more processors to identify a data rate at which the packet had been transmitted.

11. A method, comprising:
receiving an input from a user that sets a mode for a test and measurement instrument to a mixed mode indicating that packets may be from one or more versions of a serial bus standard;
receiving one or more packets from one DUT of one or more DUTs;
determining the version of the serial bus standard with which the one DUT complies by identifying a characteristic of the packet;
using the version of the serial bus standard to decode the packets to produce decoded data and
displaying the decoded data on a user interface of the test and measurement instrument.

12. The method as claimed in claim 11, wherein the mixed mode comprises a mode in which the devices operate using a single bus without regard to versions of the serial bus standard to which each of the one or more DUTs comply.

13. The method as claimed in claim 11, wherein the serial bus comprises a Controller Area Network (CAN) bus.

14. The method as claimed in claim 13, wherein the version of the serial bus standard comprises one of CAN 2.0, CAN with flexible data rate (CANFD), and CAN with extended data field length (CANXL).

15. The method as claimed in claim 11, wherein determining the version of the serial bus standard by the identifying the characteristic of the packet comprises identifying one or more key bits.

16. The method as claimed in claim 15, wherein the one or more key bits comprise at least one of a Remote Transmission Request (RTR), Identifier Extension (IDE), Remote Request Substitution, (RRS), Substitute Remote Request (SRR), control bit r0, control bit r1, reserved bit res, FDF, XLF, and resXL.

17. The method as claimed in claim 1, further comprising displaying the decoded data with search marks to allow the user to identify packets from different versions of the serial bus standard.

18. The method as claimed in claim 1, wherein the serial bus comprises a Universal Serial Bus (USB).

19. The method as claimed in claim 18, wherein the version of the serial bus standard comprises one of USB 1.0, USB 1.1, USB 2.0, USB 3.0, USB 3.1, USB 3.2 Gen 1, USB 3.0 Gen 2.

20. The method as claimed in claim 19, wherein determining the version of the serial bus standard by identifying the characteristic of the packet comprises identifying a data rate at which the packet had been transmitted.
